(19) United States
(12) Patent Application Publication
(10) Pub. No.: US 2021/0352906 A1
(43) Pub. Date: Nov. 18, 2021

(54) ANTIBACTERIAL COATING MATERIAL, METHOD OF MANUFACTURING AN ANTIBACTERIAL COATING MATERIAL, ANTIBACTERIAL COATING LAYER AND ANTIVIRAL ADHESIVE TAPE

(71) Applicant: Hsin Fukuang PAINTING CO., LTD., Kaohsiung City (TW)

(72) Inventor: Chien-Cheng LIN, Kaohsiung City (TW)

(21) Appl. No.: 17/317,937

(22) Filed: May 12, 2021

(30) Foreign Application Priority Data
May 13, 2020 (TW) 109115896

(51) Int. Cl. A01N 59/16; A01N 25/10; A01N 25/12; A01N 25/34; A01N 25/24

(52) U.S. Cl. CPC A01N 59/16; A01N 25/10; A01N 25/24; A01N 25/34; A01N 25/12

(57) ABSTRACT

Antibacterial coating material includes a coating-material main component, silicon dioxide powder and a nano antibacterial solution, wherein when the antibacterial coating material is hardened to an antibacterial coating layer, silicon dioxide particles of the silicon dioxide powder can gather most of nano antibacterial particles of the nano antibacterial solution to a position near a surface of the antibacterial coating layer, so that the nano antibacterial particles cannot be wasted, and cost of the nano antibacterial solution can be reduced. Moreover, most of the nano antibacterial particles are gathered near a surface layer of the antibacterial coating layer, so that the antibacterial effect of the antibacterial coating layer cannot be limited, and the best antibacterial effect can be achieved. Furthermore, if the nano antibacterial particles of the nano antibacterial solution have an antiviral effect, the dried nano antibacterial particles also have an antiviral effect.

### CROSS-REFERENCE TO RELATED APPLICATION

This application claims the benefit of Taiwan Patent Application No. 109115896, filed on May 13, 2020, which is hereby incorporated by reference for all purposes as if fully set forth herein.

### BACKGROUND

### Technical Field

The present disclosure relates to an antibacterial coating material, a method of manufacturing an antibacterial coating material, and an antibacterial coating layer, and particularly relates to the antibacterial coating layer in which a plurality of silicon dioxide particles can gather a plurality of nano antibacterial particles to a position near a surface of the antibacterial coating layer.

### Related Art

With social development, people's awareness of health and environmental protection is increasing. For example, in the field of surface coating, only aesthetic and protective coatings for a product can no longer meet the requirements. People also hope that coatings can have healthy effects at the same time.

Antibacterial coating material is one example. Nano antibacterial particles have unique physical and chemical properties due to their small size effect and surface effect. If nano antibacterial particles are added to a coating material, the resulting coating material has an antibacterial effect. The conventional antibacterial coating material can be divided into two types. One is photocatalytic antibacterial coating material with nano titanium dioxide or nano zinc oxide as nano antibacterial particles. The photocatalytic nano antibacterial coating material has good antibacterial properties under conditions of ultraviolet light, oxygen, water and the like. The other is antibacterial coating material with nano metallic silver as nano antibacterial particles. The antibacterial effect of nano metallic silver is less affected by the environment, so the nano metallic silver has a wide range of applications.

Please refer to FIG. 1, after a coating step, a sterilization principle of nano antibacterial particles 21 in antibacterial coating material 20 is mainly that the nano antibacterial particles 21 are in contact with bacteria 3 in the air and destroy cell membranes 31 of the bacteria 3, so that tissue fluid of the bacteria 3 flows out, and protein coagulates to make the bacteria 3 lose activity. Finally, DNA synthesis of the bacteria 3 is blocked, and the bacteria 3 lose an ability to divide and multiply, and die, and an antibacterial effect is achieved indeed.

However, whether nano titanium dioxide or nano zinc oxide is used as the nano antibacterial particles 21, or nano metallic silver is used as the nano antibacterial particles 21, the nano antibacterial particles 21 are added to the antibacterial coating material 20 by mixing and stirring before the coating step, so most of the nano antibacterial particles 21 are dispersed into a center of the antibacterial coating material 20, and only a few nano antibacterial particles 21 are near a surface of the antibacterial coating material 20. In this way, most of the nano antibacterial particles 21 in the center of the antibacterial coating material 20 are not easy to perform sterilization and will be wasted; and only a few nano antibacterial particles 21 are near the surface of the antibacterial coating material 20, the antibacterial effect of the conventional antibacterial coating material 20 is limited.

Therefore, antibacterial coating material, a method of manufacturing an antibacterial coating material, and an antibacterial coating layer are needed to overcome the above problems.

### SUMMARY

One of the objectives of the present disclosure is to provide an antibacterial coating layer, in which a plurality of silicon dioxide particles can gather a plurality of nano antibacterial particles to a position near a surface of the antibacterial coating layer.

To achieve the above objective, the present disclosure provides an antibacterial coating material, including: a coating-material main component, comprising at least one aqueous resin, a plurality of coating-material additives, and the balance of water; silicon dioxide (SiO₂) powder, mixed in the coating-material main component, and comprising a plurality of silicon dioxide particles, wherein the antibacterial coating material comprises: less than 9 wt % of the silica dioxide powder; and a nano antibacterial solution, also mixed in the coating-material main component and comprising a plurality of nano antibacterial particles, wherein when the antibacterial coating material is hardened to an antibacterial coating layer, the silicon dioxide particles are adapted to gather the nano antibacterial particles to a position near a surface of the antibacterial coating layer; the antibacterial coating layer comprises a surface layer and an intermediate layer; and a quantitative proportion of the nano antibacterial particles in the surface layer is greater than a quantitative proportion of the nano antibacterial particles in the intermediate layer.

The present disclosure further provides a method of manufacturing an antibacterial coating material, including the following steps: providing a coating-material main component, wherein the coating-material main component comprises at least one aqueous resin, a plurality of coating-material additives, and the balance of water; mixing silicon dioxide (SiO₂) powder in the coating-material main component, wherein the silicon dioxide powder comprises a plurality of silicon dioxide particles, wherein the antibacterial coating material comprises: less than 9 wt % of the silica dioxide powder; and mixing a nano antibacterial solution in the coating-material main component to complete the antibacterial coating material, wherein the nano antibacterial solution comprises a plurality of nano antibacterial particles; when the water is volatilized and the antibacterial coating material is hardened to an antibacterial coating layer, the silicon dioxide particles are adapted to gather the nano antibacterial particles to a position near a surface of the antibacterial coating layer; the antibacterial coating layer comprises a surface layer and an intermediate layer; and a quantitative proportion of the nano antibacterial particles in the surface layer is greater than a quantitative proportion of the nano antibacterial particles in the intermediate layer.

The present disclosure further provides an antibacterial coating layer, including: a coating-material main component, comprising at least one aqueous resin, and a plurality of coating-material additives; a plurality of silicon dioxide particles, mixed in the coating-material main component, wherein the antibacterial coating layer includes: less than 9 wt % of the silica dioxide particles; and a plurality of nano antibacterial particles, located in the coating-material main component, and gathered to a position near a surface of the antibacterial coating layer; the antibacterial coating layer further comprises a surface layer and an intermediate layer; and a quantitative proportion of the nano antibacterial particles in the surface layer is greater than a quantitative proportion of the nano antibacterial particles in the intermediate layer. The present disclosure further provides an antiviral adhesive tape, including: an adhesive film; and an antibacterial coating layer, being the above-mentioned antibacterial coating layer, and arranged on the adhesive film.

According to the antibacterial coating layer of the present disclosure, the silicon dioxide particles can gather most of the nano antibacterial particles to a position near the surface of the antibacterial coating layer, so that the nano antibacterial particles cannot be wasted, and the cost of the nano antibacterial solution can be reduced. Most of the nano antibacterial particles are gathered near the surface layer of the antibacterial coating layer, so that the antibacterial effect of the antibacterial coating layer cannot be limited, and the best antibacterial effect can be achieved.

### BRIEF DESCRIPTION OF THE DRAWINGS

FIG. 1 is a schematic cross-sectional view of conventional antibacterial coating material.

FIG. 2 is a flow chart of a method of manufacturing an antibacterial coating material of an embodiment of the present disclosure.

FIG. 3a is a schematic cross-sectional view of an antibacterial coating layer of an embodiment of the present disclosure.

FIG. 3b is a schematic cross-sectional view of an antiviral adhesive tape of an embodiment of the present disclosure.

FIG. 4 is a schematic cross-sectional view of an antibacterial coating layer of an embodiment of the present disclosure, showing that most of nano antibacterial particles are in contact with bacteria in the air.

### DETAILED DESCRIPTION

In order to make the above objectives, features and characteristics of the present disclosure more obvious and understandable, relevant embodiments of the present disclosure will be described in detail as follows with reference to the drawings.

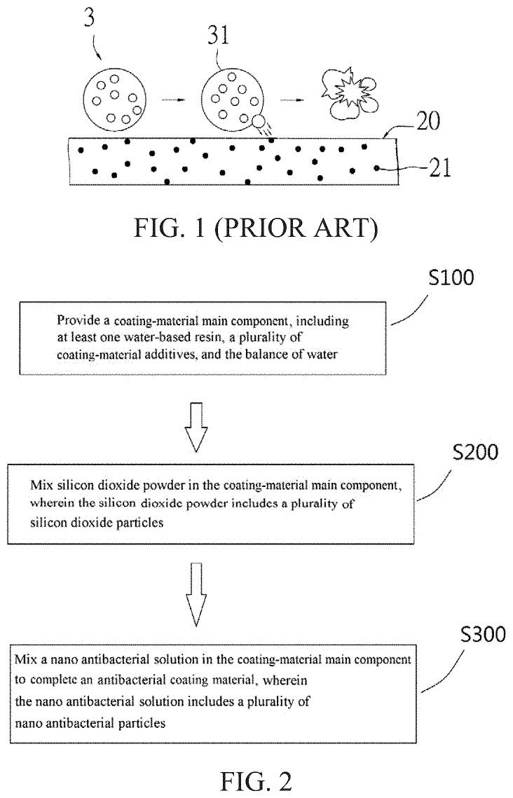

Please refer to FIG. 2, it shows a flow chart of a method of manufacturing an antibacterial coating material of an embodiment of the present disclosure. The method of manufacturing the antibacterial coating material includes the following steps.

In step S100, a coating-material main component is provided, the coating-material main component includes at least one aqueous resin (any coating material that can be diluted with water is defined as aqueous coating material), a plurality of paint additives, and the balance of water. For example, the coating-material main component includes 50-80% of aqueous resin, 2-10% of coating-material additives and the balance of water. Preferably, the coating-material main component includes 60-70% of aqueous resin, 3-9% of coating-material additives and the balance of water. In the present embodiment, the aqueous resin, the coating-material additives and the balance of water are mixed to form the coating-material main component. According to a color requirement of the coating-material main component, the aqueous coating material may further include a color paste. The aqueous resin can be selected from at least one of acrylic resin, polyurethane dispersion resin, aqueous polyurethane (PUD) resin and aqueous polyurethane acrylate resin. The coating-material additives are selected from a plurality of a aqueous defoamer, a aqueous leveling agent, a aqueous wetting and dispersing agent, a aqueous thickener, an adherence promoter, a pinhole-eliminating additive, a neutralizer, matting powder, a photoinitiator and an anti-settling agent.

For example, a formulation of a first coating-material main component is: 65% of UV curable resin (e.g., aqueous polyurethane acrylate resin), 0.5% of a aqueous defoamer (e.g., organosilicon acrylate resin), 0.5% of a aqueous leveling agent (e.g., polyether-siloxane copolymer), 3-5% of a photoinitiator (e.g., trimethylbenzoyl, and diphenylphosphine oxide) and the balance of water.

For example, a formulation of a second coating-material main component is: 50 KG of first aqueous resin (e.g., acrylic resin), 50 KG of second aqueous resin (e.g., polyurethane dispersion resin), 0.4 KG of a first defoamer (e.g., a polyether-siloxane copolymer emulsion), 2 KG of an adherence promoter, 1.2 KG of a second defoamer (e.g., a xylene polysiloxane emulsion), 4 KG of reverse osmosis (RO) water, 0.5 KG of a pinhole-eliminating additive, and 11 KG of a black color paste.

For example, a formulation of a third coating-material main component is: 41 KG of first aqueous resin (e.g., acrylic resin), 41 KG of second aqueous resin (e.g., polyurethane dispersion resin), 10 KG of reverse osmosis (RO) water, 0.2 KG of a defoamer (e.g., a polyether-siloxane copolymer emulsion), 3.4 KG of a silver color paste, 2.6 KG of an anti-settling agent, and 2 KG of an adherence promoter.

In step S200, silicon dioxide (SiO₂) powder is mixed in the coating-material main component, wherein the silicon dioxide powder includes a plurality of silicon dioxide particles 13. For example, the silicon dioxide powder is stirred and mixed in the coating-material main component by stirring at 2000 rpm for 20 minutes continuously. A particle size of the silicon dioxide particles 13 is in a range of 1-10 microns. An antibacterial coating material includes: less than 9 wt % of the silica dioxide powder (or, an antibacterial coating layer includes: less than 9 wt % of the silica dioxide particles) to avoid adding too much silica dioxide powder (i.e., silica dioxide particles) to cause the gloss of the coating material below the design value.

In step S300, a nano antibacterial solution is also mixed in the coating-material main component to complete an antibacterial coating material, wherein the nano antibacterial solution includes a plurality of nano antibacterial particles 11. For example, based on a total weight of 100 wt %, the antibacterial coating material includes: 1-3 wt % of the silicon dioxide (SiO₂) powder, 3-15 wt % of the nano antibacterial solution, and the balance of the coating-material main component. Preferably, the antibacterial coating material includes: 1-2 wt % of the silicon dioxide (SiO₂) powder, 4-6 wt % of the nano antibacterial solution, and the balance of the coating-material main component.

The nano antibacterial particles 11 adopt nano metal or nano metallic oxide. The nano metal can be nano metallic silver, and the nano metallic oxide can be nano titanium dioxide or nano zinc oxide. In the present embodiment, the present disclosure uses both nano metallic silver and nano titanium dioxide to achieve a better antibacterial effect. If the nano antibacterial solution is diluted with water, the nano antibacterial solution can be defined as a aqueous nano antibacterial solution. For example, the plurality of nano antibacterial particles 11 may be from 0.05-2% of nano metallic silver and the balance of water as a solvent. Preferably, a content of the nano metallic silver is 0.5-1.5%. A particle size of the nano antibacterial particles 11 is less than 10 nanometers, preferably is in a range of about 3-5 nanometers. Regarding a concentration of the nano antibacterial particles 11, a nano antibacterial solution containing the nano antibacterial particles 11 at 10000-12000 ppm can be used to make the antibacterial effect better.

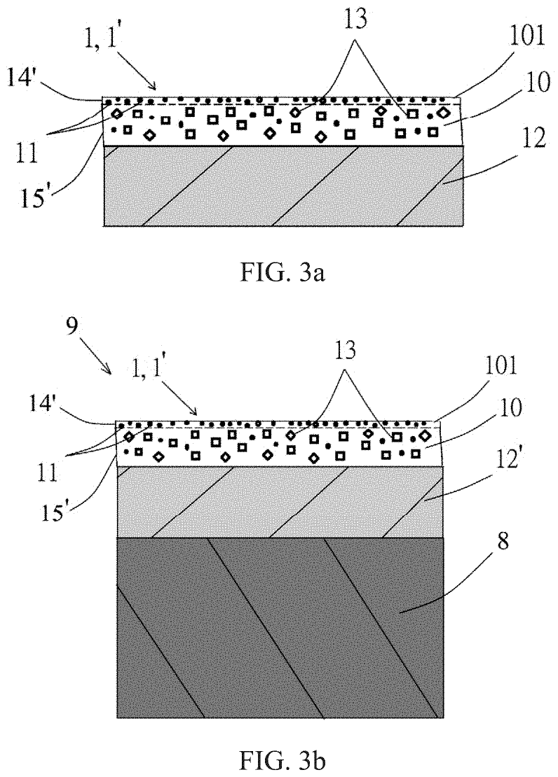

Please refer to FIG. 3a, when the water is volatilized and the antibacterial coating material 1 is hardened to an antibacterial coating layer 1′, the silicon dioxide particles 13 can gather the nano antibacterial particles 11 to a position near a surface 101 of the antibacterial coating layer 1′. The antibacterial coating layer 1′ includes a surface layer 14′ and an intermediate layer 15′. A quantitative proportion of the nano antibacterial particles 11 in the surface layer 14′ is greater than that in the intermediate layer 15′. In other words, at the time, the antibacterial coating layer 1′ includes: a coating-material main component 10, including at least one aqueous resin and a plurality of coating-material additives; a plurality of silicon dioxide particles 13, mixed in the coating-material main component 10; and a plurality of nano antibacterial particles 11, located in the coating-material main component 10 and gathered to a position near the surface 101 of the antibacterial coating layer 1′. The quantitative proportion of the nano antibacterial particles 11 in the surface layer 14′ is 60-90%, and the quantitative proportion of the nano antibacterial particles 11 in the intermediate layer 15′ is 10-40%. Preferably, when the quantitative proportion of the nano antibacterial particles 11 in the surface layer 14′ is 80-90%, the antibacterial effect is better. In the present embodiment, a thickness of the surface layer 14′ and a thickness of the intermediate layer 15′ respectively accounts for 10% and 90% of a total thickness (i.e., a superimposed thickness of the surface layer 14′ and the intermediate layer 15′) of the antibacterial coating layer 1′. For example, the thickness of the antibacterial coating layer 1′ is 5 μm or more, and the greater the thickness of the antibacterial coating layer 1′, the greater the quantity of the nano antibacterial particles 11 in the surface layer 14′.

Please refer to FIG. 3a again, the antibacterial coating material 1 can be coated onto a substrate 12 and be hardened to the antibacterial coating layer 1′, wherein the intermediate layer 15′ is located between the surface layer 14′ and the substrate 12. An abrasion resistance test between the nano antibacterial particles 11 and the coating-material main component 10 of the antibacterial coating layer 1′ is that: the abrasion is performed on the surface layer of the antibacterial coating layer 1′ with a non-woven fabric (soaked with water) with a pressure of 1.8 kg/cm², and the number of abrasion cycles is greater than 3000. The adherence between the nano antibacterial particles 11 and the coating-material main component 10 of the antibacterial coating layer 1′ is 5b, wherein the adhesion being 5b refers to the method B (Cross-cut) of the adhesion classification of ASTM D3359 test: the edges of the score lines are extremely smooth and the coating material of the square grid does not have any detachment. The coating method adopts at least one of bar coating, slide coating, curtain coating and spray coating, and the substrate 12 can be an organic substrate (e.g., wood or plastic) or an inorganic material (e.g., metal or glass).

In addition, please refer to FIG. 3b, the antibacterial coating material 1 can be coated onto an adhesive film 12′ and be hardened to the antibacterial coating layer 1′. That is, the antibacterial coating layer 1′ is disposed on the adhesive film 12′ to complete an antiviral adhesive tape 9. The antiviral adhesive tape 9 is attached onto various objects 8 by an attaching property (e.g., adhesive attaching or electrostatic attaching) of the adhesive film 12′. For example, the objects 8 may be various objects that a human hand will touch, for example, a screen of an electronic product (a mobile phone, a touch panel, etc.), a keyboard or a mouse, a desktop, various grips, various switches, and the like. The adhesive film 12′ can be a transparent adhesive film or a colored adhesive film.

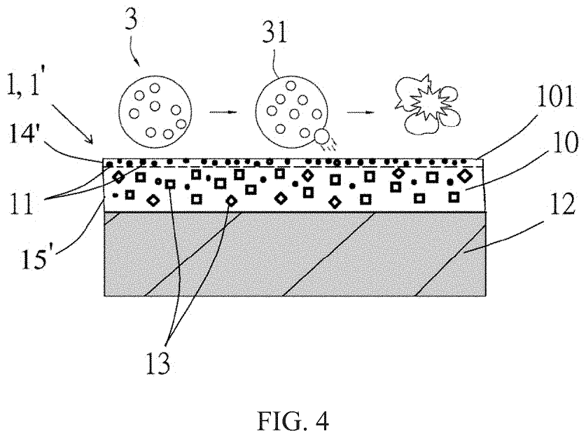

Please refer to FIG. 4, most of the nano antibacterial particles 11 of the present disclosure are in contact with the bacteria 3 in the air and destroy the cell membranes 31 of the bacteria 3, so that the tissue fluid of the bacteria 3 flows out, and protein coagulates to make the bacteria 3 lose activity. Finally, DNA synthesis of the bacteria 3 is blocked, the bacteria 3 lose the ability to divide and multiply, and die, and the antibacterial effect is achieved indeed. Furthermore, if the nano antibacterial particles 11 of the nano antibacterial solution of the present disclosure have an antiviral effect, the dried nano antibacterial particles also have an antiviral effect.

According to the antibacterial coating layer of the present disclosure, the silicon dioxide particles can gather most of the nano antibacterial particles to a position near the surface of the antibacterial coating layer, so that the nano antibacterial particles cannot be wasted, and the cost of the nano antibacterial solution can be reduced. Most of the nano antibacterial particles are gathered near the surface layer of the antibacterial coating layer, so that the antibacterial effect of the antibacterial coating layer cannot be limited, and the best antibacterial effect can be achieved (for example, the 15 g/m2 antibacterial effect is greater than 99%, please refer to JIS Z2801 for performing an antibacterial test, strain: Escherichia coli).

In addition, the applicant's further experiments are as follows:

In a first experiment, the surface layer of the antibacterial coating layer shown in FIG. 3 of the present disclosure was scraped off, and then the antibacterial coating layer without the surface layer was subjected to an antibacterial test. However, the antibacterial effect of such an antibacterial coating layer is not good (for example, the 15 g/m2 antibacterial effect is less than 99%, please refer to JIS Z2801 for performing the antibacterial test, strain: Escherichia coli). Therefore, it can be proved that most of the nano antibacterial particles of the present disclosure are gathered near the surface layer of the antibacterial coating layer. Once the nano antibacterial particles on the surface layer are scraped off, the antibacterial effect of the antibacterial coating layer is certainly not good.

In a second experiment, in step S200 of the present disclosure, silicon dioxide powder was not mixed in the coating-material main component, and then the nano antibacterial solution was mixed in the coating-material main component to obtain another kind of antibacterial coating material. The antibacterial coating material was coated onto another substrate and hardened to another antibacterial coating layer. However, the antibacterial effect of such antibacterial coating layer is not good (for example, the 15 g/m2 antibacterial effect is less than 99%, please refer to JIS Z2801 for performing the antibacterial test, strain: Escherichia coli). Since silicon dioxide powder was not mixed in the coating-material main component, no silicon dioxide particles can gather most of the nano antibacterial particles to the position near the surface of the antibacterial coating layer, and the antibacterial effect of the antibacterial coating layer is certainly not good. Accordingly, it can be proved that the silicon dioxide particles can make most of the nano antibacterial particles located at the position near the surface layer of the antibacterial coating layer.

The applicant further entrusted the Japanese BOKEN Quality Evaluation Institute to carry out the antiviral test of the present disclosure, and obtained a quality test report with an excellent antiviral effect as follows:
Delivery date: Jul. 20, 2020,
Sample name: Novel PN 5229 film coated with JM nano composite material (i.e., the antibacterial coating layer of the present disclosure),
Quantity: 2
Test item: Antiviral test
Reference specifications: ISO21702, JIS R 1702
Test method: A virus solution of about 10⁸ PFU/ml or more was prepared in an MEM medium, and diluted with sterilized distilled water for 10 times to prepare a virus solution for testing for later use. After 0.4 ml of the virus solution for testing was inoculated on a 5 cm square test sample, the test sample was covered with a 4 cm square cover glass. The test sample was placed under a black fluorescent lamp and irradiated for 4 hours. After irradiation, the test sample was put into a zipper bag and 10 ml of eluent was added, and the test sample was kneaded thoroughly to wash out the virus. An infection value of the virus in the eluate was measured, and a “PN 5229 film (blank sample)” was used as a control sample to measure data after irradiation for 4 hours and just after inoculation. The type of a light source is black light fluorescent lamp 20 w with 2 tubes (TOSHIBA FL20S BLB). A UV integrated light meter is from Hamamatsu Photonics K.K., C10427, H10428. The irradiation conditions are 0.25 mW/cm², 4 hours (25±5° C.). The type of the cover glass is an OHP cover glass. The type of a moisturizing glass is borosilicate glass. The eluent is an SCDLP medium. The test method of the virus infection value is Plaque assay.
Test virus: Influenza A virus (H1N1), ATCC VR-1469
Test results: the concentration of a test virus solution is 3.1×10⁷ PFU/ml.

| | Common | Antiviral |
|---|---|---|
| | logarithm of | activity |
| Sample name | infectivity titer | value |
| PN 5229 film (blank | 5.66 | — |
| sample), immediately | | |
| after inoculation (Uₒ) | 4.22 | — |
| PN 5229 film (blank | | |
| sample), later 4 hours (Uₜ) | | |
| Novel PN 5229 film coated | <0.80 | 3.4 |
| with JM nano composite | | |
| material (JM-TTA01) (Aₜ) | | |

Remarks: Calculation of antiviral activity value is in ISO21702: 2019, and a calculation method is: antiviral activity value=Uₜ−Aₜ; and the test was performed by the Osaka Microbiology Laboratory.

The foregoing descriptions are merely the preferred implementations or embodiments of the technical means adopted by the present disclosure to solve the problems, but are not intended to limit the claims of the present disclosure. That is, all the equivalent alterations and modifications made in accordance with the literary content of the claims of the present disclosure or made in accordance with the claims of the present disclosure are all covered by the claims of the present disclosure.

What is claimed is:

1. Antibacterial coating material, comprising:
a coating-material main component, comprising at least one aqueous resin, a plurality of coating-material additives, and the balance of water;
silicon dioxide (SiO₂) powder, mixed in the coating-material main component, and comprising a plurality of silicon dioxide particles, wherein the antibacterial coating material comprises: less than 9 wt % of the silica dioxide powder; and
a nano antibacterial solution, also mixed in the coating-material main component and comprising a plurality of nano antibacterial particles, wherein when the antibacterial coating material is hardened to an antibacterial coating layer, the silicon dioxide particles are adapted to gather the nano antibacterial particles to a position near a surface of the antibacterial coating layer; the antibacterial coating layer comprises a surface layer and an intermediate layer; and a quantitative proportion of the nano antibacterial particles in the surface layer is greater than a quantitative proportion of the nano antibacterial particles in the intermediate layer.

2. The antibacterial coating material of claim 1, wherein based on a total weight of 100 wt %, the antibacterial coating material comprises: 1-3 wt % of the silicon dioxide powder, 3-15 wt % of the nano antibacterial solution, and the balance of the coating-material main component.

3. The antibacterial coating material of claim 2, wherein a concentration of the nano antibacterial particles in the nano antibacterial solution is 10000-12000 ppm.

4. The antibacterial coating material of claim 1, wherein the quantitative proportion of the nano antibacterial particles in the surface layer is 60-90%, the quantitative proportion of the nano antibacterial particles in the intermediate layer is 10-40%, and the nano antibacterial particles adopt nano metal or nano metallic oxide.

5. The antibacterial coating material of claim 4, wherein when the nano antibacterial particles adopt nano metal, the nano metal is nano metallic silver; and when the nano antibacterial particles adopt nano metallic oxide, the nano metallic oxide is nano titanium dioxide or nano zinc oxide.

6. A method of manufacturing an antibacterial coating material, comprising the following steps:
providing a coating-material main component, wherein the coating-material main component comprises at least one aqueous resin, a plurality of coating-material additives, and the balance of water;
mixing silicon dioxide (SiO₂) powder in the coating-material main component, wherein the silicon dioxide powder comprises a plurality of silicon dioxide particles, wherein the antibacterial coating material comprises: less than 9 wt % of the silica dioxide powder; and
mixing a nano antibacterial solution in the coating-material main component to complete the antibacterial coating material, wherein the nano antibacterial solution comprises a plurality of nano antibacterial particles; when the water is volatilized and the antibacterial coating material is hardened to an antibacterial coating layer, the silicon dioxide particles are adapted to gather the nano antibacterial particles to a position near a surface of the antibacterial coating layer; the antibacterial coating layer comprises a surface layer and an intermediate layer; and a quantitative proportion of the nano antibacterial particles in the surface layer is greater than a quantitative proportion of the nano antibacterial particles in the intermediate layer.

7. The method of manufacturing an antibacterial coating material of claim 6, wherein the silicon dioxide powder is stirred and mixed in the coating-material main component by stirring at 2000 rpm for 20 minutes continuously.

8. The method of manufacturing an antibacterial coating material of claim 6, wherein based on a total weight of 100 wt %, the antibacterial coating material comprises: 1-2 wt % of the silicon dioxide powder, 4-6 wt % of the nano antibacterial solution, and the balance of the coating-material main component; and a concentration of the nano antibacterial particles in the nano antibacterial solution is 10000-12000 ppm.

9. An antibacterial coating layer, comprising:
a coating-material main component, comprising at least one aqueous resin, and a plurality of coating-material additives;
a plurality of silicon dioxide particles, mixed in the coating-material main component, wherein the antibacterial coating layer includes: less than 9 wt % of the silica dioxide particles; and
a plurality of nano antibacterial particles, located in the coating-material main component, and gathered to a position near a surface of the antibacterial coating layer; the antibacterial coating layer further comprises a surface layer and an intermediate layer; and a quantitative proportion of the nano antibacterial particles in the surface layer is greater than a quantitative proportion of the nano antibacterial particles in the intermediate layer.

10. The antibacterial coating layer of claim 9, wherein the quantitative proportion of the nano antibacterial particles in the surface layer is 60-90%, the quantitative proportion of the nano antibacterial particles in the intermediate layer is 10-40%, and the nano antibacterial particles adopt nano metal or nano metallic oxide; when the nano antibacterial particles adopt nano metal, the nano metal is nano metallic silver; and when the nano antibacterial particles adopt nano metallic oxide, the nano metallic oxide is nano titanium dioxide or nano zinc oxide.

11. The antibacterial coating layer of claim 9, wherein an abrasion resistance test between the nano antibacterial particles and the coating-material main component of the antibacterial coating layer is: abrasion is performed on the surface layer of the antibacterial coating layer with a non-woven fabric (soaked with water) with a pressure of 1.8 kg/cm2, and the number of abrasion cycles is greater than 3000; and adherence between the nano antibacterial particles and the coating-material main component of the antibacterial coating layer is 5b.

12. An antiviral adhesive tape, comprising:
an adhesive film; and
an antibacterial coating layer, being the antibacterial coating layer of claim 9, and arranged on the adhesive film.
